(19) United States
(12) Patent Application Publication
(10) Pub. No.: US 2014/0374130 A1
(43) Pub. Date: Dec. 25, 2014

(54) Impact Tool

(71) Applicant: Hitachi Koki Co., Ltd., Tokyo (JP)

(72) Inventors: Mizuho Nakamura, Hitachinaka (JP); Nobuhiro Takano, Hitachinaka (JP); Tomomasa Nishikawa, Hitachinaka (JP); Hironori Mashiko, Hitachinaka (JP)

(21) Appl. No.: 14/372,320

(22) PCT Filed: Mar. 4, 2013
(86) PCT No.: PCT/JP2013/001307

§ 371 Date: Jul. 15, 2014

(30) Foreign Application Priority Data
Mar. 13, 2012 (JP) 2012-055379

(51) Int. Cl. B25D 16/00; B25D 11/00

(52) U.S. Cl. CPC B25D 16/006; B25D 11/00
USPC 173/176; 173/2; 173/48

(57) ABSTRACT

An impact tool includes a motor, a hammer, an anvil, and a control unit. The hammer is configured to be driven by the motor and be movable in an axial direction of the motor. The anvil is configured to be struck by the hammer. The control unit is configured to control a rotation of the motor. The impact tool further includes a restricting unit configured to restrict the movement of the hammer in the axial direction. The control unit is configured to select a driving mode of the motor between a first mode and a second mode. The control unit selects the first mode when a load of the motor is less than or equal to a prescribed value regardless of a restriction of the restricting unit, whereas the control unit selects the second mode when the load exceeds the prescribe value and the restricting unit restricts the movement of the hammer.

### TECHNICAL FIELD

The invention relates to an impact tool, and particularly to an impact tool that generates striking force mechanically and electrically.

### BACKGROUND ART

A conventional impact driver as disclosed in Japanese Patent Application Publication No. 2008-307664 includes a motor having an output shaft, a control circuit that controls driving of the motor, a hammer driven by the motor and rotates in a certain direction, a spring for urging the hammer in the axial direction of the output shaft, an anvil that is struck in the certain direction by the hammer, and an end bit held by the anvil. The hammer rotates together with the anvil when a load on the anvil is less than a predetermined magnitude, and strikes the anvil when the load on the anvil becomes the predetermined magnitude or greater. Rotation of the hammer together with the anvil (or striking the anvil) causes its rotational force (striking force) to be transmitted to the end bit.

When a load of a predetermined magnitude or greater is exerted on the anvil, the hammer moves in the axial direction against the urging force of the spring. When the hammer moves a predetermined amount or greater, the hammer becomes rotatable relative to the anvil and strikes the anvil due to the urging force of the spring.

### DISCLOSURE OF INVENTION

### Solution to Problem

In the conventional impact driver, when the hammer strikes the anvil, the hammer applies an impact in the axial direction in addition to an impact in the circumferential direction. Hence, there is a problem that the impact in the axial direction resonates through a workpiece, and operation noises during a fastening operation become large. Further, because the motor rotates continuously in one direction, strong fastening can be performed with continuous strike, whereas detailed work such as performing a fastening operation suitable for the kind of a fastener cannot be performed.

Hence, an impact tool has been studied that can selectively switch between a first mode in which continuous striking can be performed and a second mode in which striking noises are reduced. The impact tool includes a restricting unit configured to restrict movement of a hammer and an electrical switch that moves in conjunction with the operation of the restricting unit. If a control circuit detects the operation of the electrical switch, a motor is controlled in the second mode.

With this configuration, however, it has been found that vibrations or the like of the impact tool during the fastening operation cause the electrical switch to have chattering and that the mode cannot be switched accurately. In addition, because the electrical switch needs to be provided, the number of parts increases and the cost also increases.

In view of the foregoing, an object of the invention is to provide an impact tool that is insusceptible to the influence of vibrations or the like during a fastening operation and that can selectively switch modes accurately with a simple configuration.

In order to attain above and other object, the present invention provides an impact tool. The impact tool includes a motor, a hammer, an anvil, and a control unit. The motor is configured to be rotatable either in a forward direction or a reverse direction. The motor has an output shaft defining an axial direction. The hammer is configured to be driven by the motor and movable in the axial direction. The anvil is configured to be struck by the hammer and hold an end tool. The control unit is configured to control a rotation of the motor. The impact tool further comprises a restricting unit configured to restrict the movement of the hammer in the axial direction. The control unit is configured to select a driving mode of the motor between a first mode and a second mode different from the first mode. The control unit includes a load detection unit configured to detect a load of the motor. The control unit selects the first mode when the load detected by the load detection unit is less than or equal to a prescribed value regardless of a restriction of the restricting unit, whereas the control unit selects the second mode when the load detected by the load detection unit exceeds the prescribe value and the restricting unit restricts the movement of the hammer.

According to another aspect, the present invention provides an impact tool. The impact tool includes a motor, a hammer, an anvil, and a control unit. The motor is configured to be rotatable either in a forward direction or a reverse direction. The motor has an output shaft defining an axial direction. The hammer is configured to be driven by the motor and movable in the axial direction. The anvil is configured to be struck by the hammer and hold an end tool. The hammer is configured to get over the anvil upon the movement in the axial direction. The control unit is configured to control a rotation of the motor. The control unit includes a current detection unit configured to detect a current flowing to the motor and a mode selecting unit configured to select a driving mode of the motor between a first mode and a second mode based on the current detected by the current detection unit. The motor is continuously rotated in one of the forward and reverse directions in the first mode. The motor is alternately rotated in the forward and reverse directions in the second mode. The mode selecting unit selects the second mode when the current detected by the current detection unit exceeds a current threshold value. The current threshold value is larger than a current when the hammer gets over the anvil.

According to still another aspect, the present invention provides an impact tool. The impact tool includes a motor, a hammer, an anvil, and a control unit. The motor is configured to be rotatable either in a forward direction or a reverse direction. The motor has an output shaft defining an axial direction. The hammer is configured to be driven by the motor and be movable in the axial direction. The anvil is configured to be struck by the hammer and hold an end tool. The hammer is configured to get over the anvil upon the movement in the axial direction. The control unit is configured to control a rotation of the motor. The control unit includes a rotational speed detection unit configured to detect a rotational speed of the motor and a mode selecting unit configured to select a driving mode of the motor between a first mode and a second mode based on the rotational speed detected by the rotational speed detection unit. The motor is continuously rotated in one of the forward and reverse directions in the first mode. The motor is alternately rotated in the forward and reverse directions in the second mode. The mode selecting unit selects the second mode when the rotational speed detected by the rotational speed detection unit is lower than or equal to a rotational threshold value. The rotational threshold value is smaller than a rotational speed when the hammer gets over the anvil.

According to still another aspect, the present invention provides an impact tool. The impact tool includes a motor, an anvil, a hammer, an urging member, and a control unit. The motor is configured to be rotatable either in a forward direction or a reverse direction. The motor has an output shaft defining an axial direction. The anvil is configured to hold an end tool, the anvil including an engaged section. The hammer is configured to be driven by the motor and be movable in the axial direction. The hammer includes an engaging section configured to engage the engaged section of the anvil so as to rotatingly drive the anvil. The urging member is configured to urge the hammer toward the anvil in the axial direction. The hammer rotatingly moves in the axial direction against the urging member, so that the engaging section gets over the engaged section. The control unit is configured to control a rotation of the motor. The control unit includes at least one of a rotational speed detection unit and a current detection unit. The rotational speed detection unit is configured to detect a rotational speed of the motor. The current detection unit is configured to detect a current flowing to the motor. The control unit further includes a mode selecting unit configured to select a driving mode of the motor between a first mode and a second mode. The motor is continuously rotated in one of the forward and reverse directions in the first mode. The motor is alternately rotated in the forward and reverse directions in the second mode. The mode selecting unit selects the second mode when the rotational speed detected by the rotational speed detection unit is lower than or equal to a rotational threshold value or when the current detected by the current detection unit exceeds a current threshold value. The current threshold value is larger than a current when the hammer gets over the anvil. The rotational threshold value is smaller than a rotational speed when the engaging section gets over the engaged section.

According to still another aspect, the present invention provides an impact tool. The motor is configured to be rotatable either in a forward direction or a reverse direction. The motor has an output shaft defining an axial direction. The hammer is configured to be driven by the motor and movable in the axial direction. The anvil is configured to be struck by the hammer and hold an end tool. The impact tool further comprises a restricting unit configured to restrict the movement of the hammer in the axial direction. The drive mode of the motor is configured to be automatically switched when the restricting unit restricts the movement of the hammer.

According to still another aspect, the present invention provides an impact tool. The motor is configured to be rotatable either in a forward direction or a reverse direction. The motor has an output shaft defining an axial direction. The hammer is configured to be driven by the motor and movable in the axial direction. The anvil is configured to be struck by the hammer and hold an end tool. The impact tool further comprises a restricting unit configured to restrict the movement of the hammer in the axial direction and a load detection unit configured to detect a load of the motor. The motor is driven in a first mode when the load detected by the load detection unit is less than or equal to a prescribed value, whereas the motor is driven in a second mode different from the first mode when the load detected by the load detection unit exceeds the prescribe value and the restricting unit restricts the movement of the hammer.

With this configuration, either the first mode or the second mode can be selected based on the load on the motor or the restriction of the restricting unit. In the first mode, striking force can be generated in a rotational direction based on movements of the hammer and the anvil in the axial direction. In the second mode, striking force can be generated in the rotational direction based on forward and reverse rotations of the motor. Hence, without using an electrical switch, a mode (continuous rotation state, forward-reverse rotation state) suitable for the load can be selected reliably.

### Advantageous Effects of Invention

According to the impact tool of the invention, an impact tool can be provided that is insusceptible to the influence of vibrations or the like during work and that can switch modes accurately with a simple configuration.

### BRIEF DESCRIPTION OF DRAWINGS

FIG. 1 is a side cross sectional view of an impact tool when the impact tool is in a permitting state according to an embodiment of a present invention;

FIG. 2 is a block diagram illustrating an electrical structure of the impact tool according to the embodiment of the present invention;

FIG. 3 is a perspective view of a restricting section of the impact tool according to the present embodiment of the present invention;

FIG. 4 is a side cross sectional view of the impact tool when the impact tool is in a blocking state according to the embodiment of the present invention;

FIG. 5(a) is a graph illustrating a relationship between a current value and an elapsed time from an operation of a trigger of the impact tool when the impact tool is in a continuous rotation state according to the embodiment of the present invention;

FIG. 5(b) is a graph illustrating a relationship between a current value and an elapsed time from the operation of the trigger when the impact tool is in a forward-reverse rotation state according to the embodiment of the present invention;

FIG. 6 is a flowchart illustrating steps in an operation shown in FIGS. 5(a) and 5(b) according to the embodiment of the present invention;

FIG. 7(a) is a graph illustrating a relationship between a current value and an elapsed time from an operation of a trigger of an impact tool when the impact tool is in a continuous rotation state according to a first modification of the embodiment of the present invention;

FIG. 7(b) is a graph illustrating a relationship between a current value and an elapsed time from the operation of the trigger when the impact tool is in a forward-reverse rotation state according to the first modification of the embodiment of the present invention;

FIG. 8 is a flowchart illustrating steps in an operation shown in FIGS. 7(a) and 7(b) according to the first modification of the embodiment of the present invention;

FIG. 9(a) is a graph illustrating a relationship between a rotational speed and an elapsed time from an operation of a trigger of an impact tool when the impact tool is in a continuous rotation state according to a second modification of the embodiment of the present invention;

FIG. 9(b) is a graph illustrating a relationship between a rotational speed and an elapsed time from the operation of the trigger when the impact tool is in a forward-reverse rotation state according to the second modification of the embodiment of the present invention;

FIG. 10 is a flowchart illustrating steps in an operation shown in FIGS. 9(a) and 9(b) according to the second modification of the embodiment of the present invention;

FIG. 11(a) is a graph illustrating a relationship between a rotational speed and an elapsed time from an operation of a trigger of an impact tool when the impact tool is in a continuous rotation state according to a third modification of the embodiment of the present invention;

FIG. 11(b) is a graph illustrating a relationship between a rotational speed and an elapsed time from the operation of the trigger when the impact tool is in a forward-reverse rotation state according to the third modification of the embodiment of the present invention; and

FIG. 12 is a flowchart illustrating steps in an operation shown in FIGS. 11(a) and 11(b) according to the third modification of the embodiment of the present invention.

### BEST MODE FOR CARRYING OUT THE INVENTION

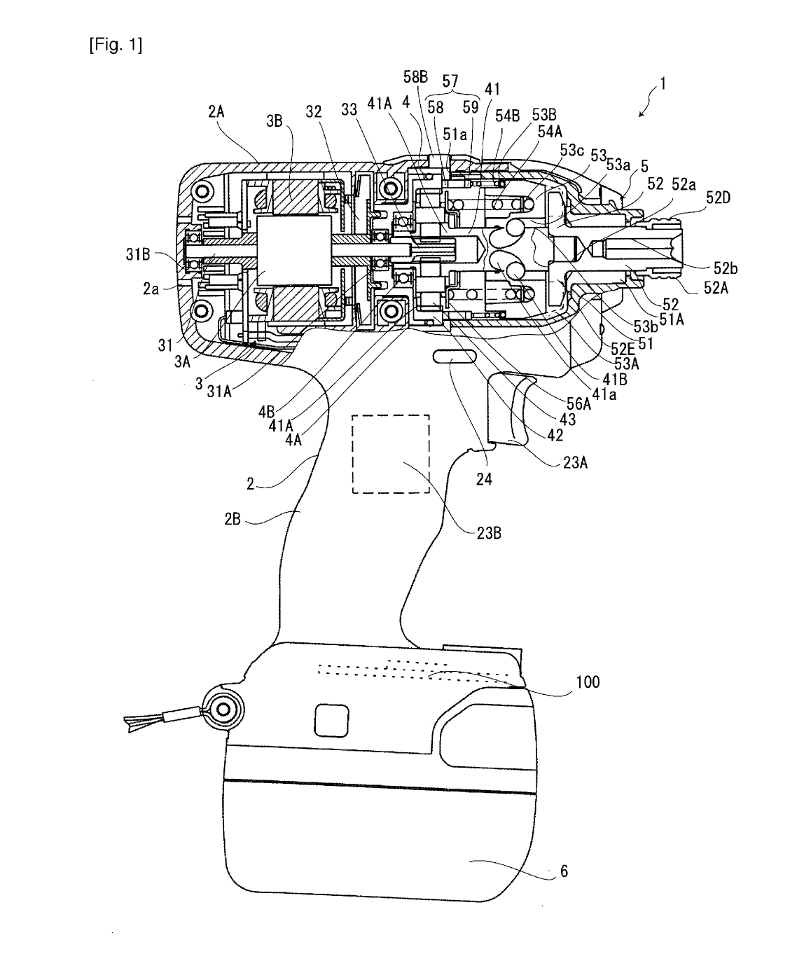

An embodiment of the invention will be described while referring to FIGS. 1 through 6. An impact tool 1 shown in FIG. 1 is a tool for fastening a bolt, a nut, and a screw with an end bit (end tool) such as a bit, a socket, etc. As shown in FIG. 1, the impact tool 1 mainly includes a housing 2, a motor 3, a gear mechanism 4, and an impact mechanism 5, and is driven by a rechargeable detachable battery 6 as the power source.

The housing 2 is a resin housing made of 6-nylon, and includes a body section 2A in which the motor 3 and the like are accommodated and a handle 2B extending from the body section 2A. The body section 2A and the handle section 2B define an accommodation space therein. The housing 2 consists of substantially symmetrical split housings that are split into two pieces by a plane extending in an upper-lower direction and a front-rear direction described later. As shown in FIG. 1, at a portion of the accommodation space within the body section 2A, the above-mentioned motor 3, the gear mechanism 4, and the impact mechanism 5 are arranged to align coaxially from one end side toward the other end side. The front-rear direction is defined such that the motor 3 side is the rear side in the axial direction along which the motor 3, the gear mechanism 4, and the impact mechanism 5 are aligned. Further, the upper-lower direction is a direction perpendicular to the front-rear direction, and is defined such that the lower direction is the direction in which the handle 2B extends from the body section 2A.

As shown in FIG. 1, an air outlet port (not shown) and an air inlet port 2a are formed in the body section 2A at front and rear positions of the motor 3, respectively. The handle 2B has a lower end portion provided with a terminal section (not shown) on which the battery 6 is detachably mounted for electrical connection. A control circuit section 100 for controlling rotation of the motor 3 is disposed at an upper portion of the terminal section (not shown). The handle 2B has a base portion provided with a trigger 23A operated by an operator and a switch section 23B accommodated within the accommodation space of the handle 2B. The switch section 23B is connected to the trigger 23A and directs the control circuit section 100 to control conduction of power supply to the motor 3. Further, a forward-reverse switching lever 24 for switching rotational direction of the motor 3 is provided at a base portion of the handle 2B above the trigger 23A. The control circuit section 100 serves as a control unit of the present invention.

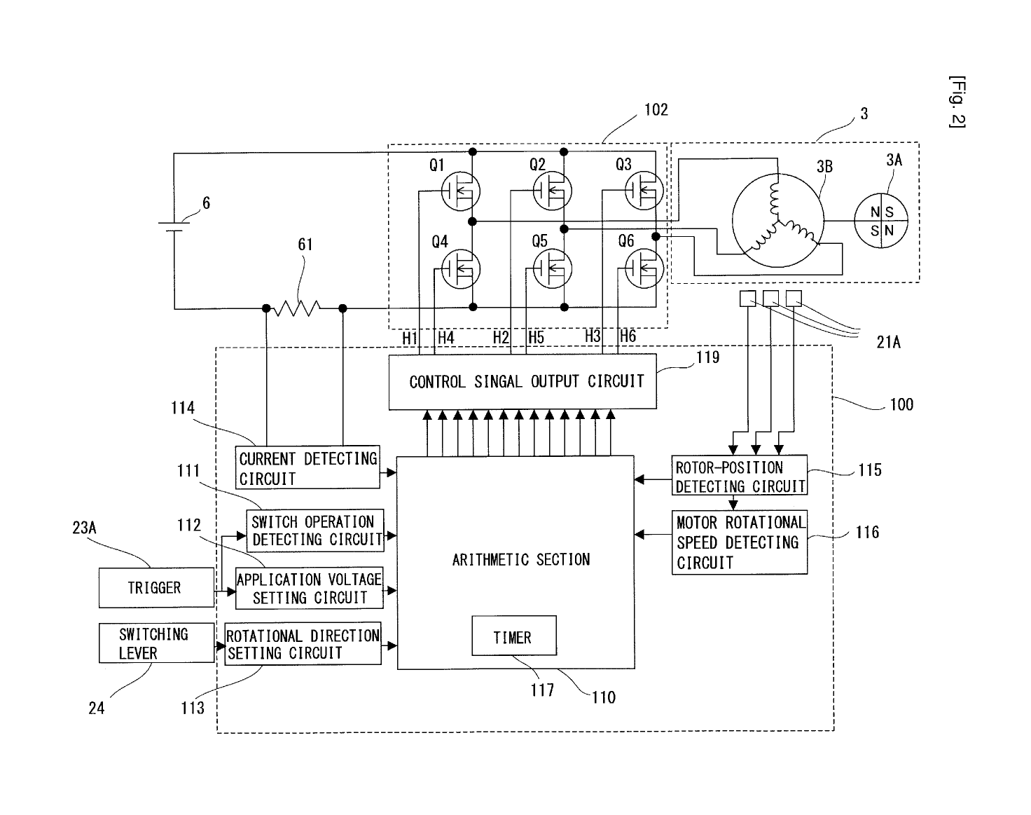

Next, the electrical circuit configuration of the control circuit section 100, the battery 6, an inverter circuit section 102 that drives the motor 3, and the motor 3 will be described while referring to FIG. 2. The control circuit section 100 includes an arithmetic section 110 which is a microcomputer, a switch-operation detecting circuit 111, an application-voltage setting circuit 112, a rotational-direction setting circuit 113, a current detecting circuit 114, a rotor-position detecting circuit 115, a motor rotational-speed detecting circuit 116, and a control-signal outputting circuit 119. Note that the current detecting circuit 114 and the motor rotational-speed detecting circuit 116 serve as load detecting unit of the invention. Also, the current detecting circuit 114 serves as a current detection unit of the invention. Further, the motor rotational-speed detecting circuit 116 serves as a rotational speed detection unit of the present invention. Further, the arithmetic section 110 serves as a mode selecting unit of the invention.

The switch-operation detecting circuit 111 detects whether the trigger 23A has been pulled, and outputs the detection result to the arithmetic section 110. The application-voltage setting circuit 112 sets a PWM duty of a PWM driving signal for driving switching elements Q1-Q6 of the inverter circuit section 102 in accordance with a target value signal outputted from the trigger 23A, and outputs the PWM duty to the arithmetic section 110.

The rotational-direction setting circuit 113 detects a state of the forward-reverse switching lever 24 and outputs the detection result to the arithmetic section 110. The current detecting circuit 114 detects the amount of current between the battery 6 and the inverter circuit section 102. Specifically, the current detecting circuit 114 detects voltage applied to a shunt resistance 61 provided on a current path between the battery 6 and the inverter circuit section 102, and outputs the detection result to the arithmetic section 110. The rotor-position detecting circuit 115 detects a rotational position of a rotor 3A of the motor 3 based on rotational-position detection signals outputted from Hall ICs 21A, and outputs the detection result to the arithmetic section 110. The motor rotational-speed detecting circuit 116 detects a rotational speed of the motor 3 from the rotational position detected by the rotor-position detecting circuit 115, and outputs the detection result to the arithmetic section 110.

The arithmetic section 110 calculates a target value (for example, 70% in a power save mode, 100% in a full power mode) of PWM duty based on an output from the application-voltage setting circuit 112. The arithmetic section 110 also determines a stator winding to be suitably energized, based on an output from the rotor-position detecting circuit 115, and generates output switching signals H1-H3 and PWM driving signals H4-H6. A duty width is determined based on a magnitude of the target value of PWM duty, and the PWM driving signals H4-H6 are outputted. The control-signal outputting circuit 119 outputs, to the inverter circuit section 102, the output switching signals H1-H3 and the PWM driving signals H4-H6 that are generated by the arithmetic section 110. The arithmetic section 110 is provided with a timer 117 which is a timer unit for measuring elapsed time.

The inverter circuit section 102 is supplied with DC power from the battery 6. In the inverter circuit section 102, the switching elements Q1-Q6 are driven based on the output switching signals H1-H3 and the PWM driving signals H4-H6, and the stator winding to be energized is determined. Further, switching of the PWM driving signal is performed based on the target value of PWM duty. With this operation, voltages of electric angle 120 degrees are sequentially applied to the three-phase stator windings (U, V, W) of the motor 3.

The motor 3 is a DC brushless motor, and mainly includes a stator 3B having the stator winding and the rotor 3A. The stator 3B has a cylindrical shape and constitutes an outer shell of the motor 3. The outer circumferential surface of the stator 3B is held by the housing 2. The rotor 3A is rotatably disposed within the stator 3B. A rotor shaft 31 extending in the front-rear direction is provided at a rotational axis position of the rotor 3A such that the rotor shaft 31 rotates coaxially together with the rotor 3A.

The rotor shaft 31 is provided with a fan 32 and a pinion gear 33 at the front end thereof so as to rotate coaxially together therewith. Also, the rotor shaft 31 has a front end portion provided with a bearing 31A so as to be rotatably supported by a frame body 4A described later. In addition, the rotor shaft 31 has a rear end portion provided with a bearing 31B so as to be rotatably supported through the bearing 31B. When the fan 32 rotates together with the rotor shaft 31, an air flow is formed to pass from the air inlet port 2a through a neighborhood of the motor 3 of the accommodation space within the body section 2A to the air outlet port (not shown).

The gear mechanism 4 is disposed at the front side of the motor 3 within the body section 2A. The gear mechanism 4 is a planetary gear mechanism in which the pinion gear 33 serves as a sun gear. The gear mechanism 4 is mounted on the housing 2 where the frame body 4A constitutes the outer shell. The gear mechanism 4 includes a spindle 41, a ring gear 42, and a plurality of planetary gears 43. The spindle 41 is a planetary carrier for supporting the plurality of planetary gears 43. The front end of the spindle 41 coaxially rotatably supports an anvil 52 described later, and the rear end of the spindle 41 is rotatably supported by the frame body 4A through a bearing 4B. The spindle 41 has a rear end portion provided with a flange section 41A for supporting the planetary gears 43 and for receiving a first spring 54A described later. A hammer 53 described later is fitted around the spindle 41 such that the hammer 53 can move in the front-rear direction. Further, the spindle 41 is formed with a pair of grooves 41a, 41a each extending obliquely with respect to the axial direction of the rotor shaft 31. Balls 41B, 41B are inserted in the respective grooves 41a, 41a, so that the spindle 41 is connected to the hammer 53 through the balls 41B, 41B.

The ring gear 42 is disposed to be positioned coaxially around the outer circumference of the spindle 41, and is fixed to the frame body 4A in a non-rotatable state. Each of the planetary gears 43 is supported by the spindle 41 so as to be rotatable about its own axis. Each of the planetary gears 43 meshingly engages the ring gear 42 and also meshingly engages the pinion gear 33. With this configuration, rotation of the pinion gear 33 is decelerated and transmitted to the spindle 41.

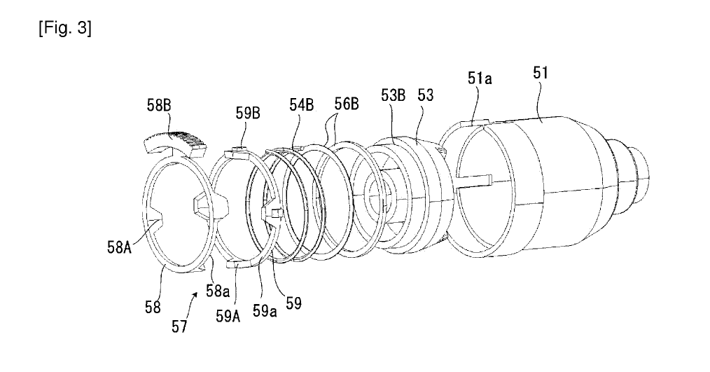

The impact mechanism 5 mainly includes a hammer case 51, the anvil 52, the hammer 53, the first spring 54A, a second spring 54B, a first washer 56A, a second washer 56B (FIG. 3), and a restricting section 57.

The hammer case 51 is of a circular cylindrical shape having a narrowed front end. The rear end section of the hammer case 51 is connected to the body section 2A of the housing 2 such that the hammer case 51 is coaxial with the motor 3. The hammer case 51 has a front end portion provided with a metal bearing 51A that rotatably supports the anvil 52. As shown in FIG. 3, the hammer case 51 has a rear end portion formed with a knob guiding groove 51a extending in the circumferential direction of the rotor shaft 31. A fixing convex section 59B (described later) is inserted in the inner circumferential surface of the hammer case 51. The inner circumferential surface of the hammer case 51 is formed with a groove (not shown) along which the fixing convex section 59B can only move forward and rearward.

As shown in FIG. 1, the anvil 52 has a circular cylindrical shape that extends in the front-rear direction. The anvil 52 is rotatably supported by the spindle 41 such that the anvil 52 is rotatably supported by the hammer case 51 through the metal bearing 51A and that a front end portion of the spindle 41 is loosely fitted into a bore 52a formed at the rear end of the anvil 52. The anvil 52 has a front end portion provided with an end-bit mounting section 52A on which a socket (not shown) is detachably mounted. The end-bit mounting section 52A mainly includes a ball (not shown) and an operating section 52D. The ball (not shown) can protrude into a mount hole 52b formed at the front end of the anvil 52. The operating section 52D is urged rearward by a spring (not shown) and makes contact with the ball (not shown) while being urged rearward so that the ball (not shown) protrudes into the mount hole 52b. The rear end of the anvil 52 is provided integrally with vane sections 52E, 52E extending outward in radial direction and serving as an engaged section.

The hammer 53 has a cylindrical shape formed with a through-hole 53a in which the spindle 41 is fitted. The hammer 53 has a front end portion provided with pawl sections 53A, 53A that can engage the respective vane sections 52E, 52E and that serve as an engaging section. The pawl sections 53A, 53A protrude forward from the front end of the hammer 53. The pawl sections 53A, 53A are arranged at positions shifted 180 degrees from each other about the axis, and have shapes that are symmetrical about with respect to the axis. When a load of a predetermined magnitude or greater is on the anvil 52, the hammer 53 moves rearward against the urging force of the first spring 54A. At this time, the rotation of the hammer 53 is temporarily halted, and only the spindle 41 rotates, and rotational energy of the spindle 41 is stored in the first spring 54A as elastic energy. And, when the pawl sections 53A get over the vane sections 52E, the elastic energy stored in the first spring 54A is released. Then the hammer 53 rotates while moving forward, and the pawl sections 53A, 53A collide with the vane sections 52E, 52E. With this configuration, the rotational force of the motor 3 is transmitted to the anvil 52 as striking force. Note that, when a load on the anvil 52 is less than the predetermined magnitude, rotation of the motor 3 is transmitted to the hammer 53, and the hammer 53 and the anvil 52 rotate together in a state where the pawl sections 53A, 53A of the hammer 53 engage the vane sections 52E, 52E of the anvil 52.

The inner surface of the through-hole 53 of the hammer 53 is formed with grooves 53b, 53b extending in the front-rear direction in which respective ones of the pair of the balls 41B, 41B are provided. A portion of each of the balls 41B, 41B is accommodated in the respective grooves 53b, 53b and a remaining portion of each of the balls 41B, 41B is accommodated in the respective grooves 41a, 41a, so that the hammer 53 can rotate coaxially together with the spindle 41. A receiving section 53c for receiving the first spring 54A is formed at the rear end side of the hammer 53, such that the receiving section 53c is formed continuously around a peripheral wall defining the through-hole 53a. The hammer 53 has an outer peripheral surface formed with a spring receiving section 53B having a stepped shape for contacting the second spring 54B. The spring receiving section 53B is formed continuously in the circumferential direction and positioned radially outward of the receiving section 53c.

The first spring 54A serves as an urging member of the present invention, and is supported by the flange section 41A of the spindle 41 via the first washer 56A. A portion of the spindle 41 located at the front side of the flange section 41A is inserted through the inside of the first spring 54A, and is further inserted in the receiving section 53c. Thus, the first spring 54A urges the hammer 53 forward in the axial direction relative to the spindle 41. The urging direction of the first spring 54A is in the axial direction and in the forward direction. A rubber serving as a cushioning member is interposed between the first washer 56A and the flange section 41A. Because the first spring 54A urges the hammer 53 forward, the pawl sections 53A, 53A of the hammer 53 can engage the vane sections 52E, 52E of the anvil 52.

Further, when the hammer 53 moves rearward relative to the anvil 52 at the time of the above-described load, the pawl sections 53A, 53A get over the vane sections 52E, 52E. At the same time, the first spring 54A causes the hammer 53 to move toward the anvil 52 side which is the front side, so that the pawl sections 53A, 53A is brought into contact with the respective vane sections 52E, 52E. In this way, because the hammer 53 rotates relative to the anvil 52 and the pawl sections 53A, 53A make contact with the vane sections 52E, 52E, striking force in the rotational direction and the axial direction is applied to the anvil 52.

The second spring 54B accommodates the spindle 41, the hammer 53, and the first spring 54A in its inner space. As shown in FIG. 3, the second spring 54B has a front end in contact with the spring receiving section 53B via the second washer 56B consisting of stacked two washers, and the rear end in contact with the restricting section 57, thereby urging the restricting section 57 rearward relative to the hammer case 51. The restricting section 57 serves as a restricting unit of the present invention.

The restricting section 57 includes a supporting section 58 and a contacting section 59. The supporting section 58 has an annular shape, and its rear end is in contact with the ring gear 42. The front end of the supporting section 58 is provided with supporting-side convex sections 58A that are arranged at four positions equally spaced in the circumferential direction and that protrude forward. Supporting-side concave sections 58a are defined at four positions each between the neighboring supporting-side convex sections 58A. Each of the supporting-side convex sections 58A has the same shape. The front end of each supporting-side convex section 58A has a planar shape that is perpendicular to the front-rear direction. The side surfaces of each supporting-side convex section 58A in the circumferential direction have a slope-face shape.

The supporting section 58 has an outer peripheral surface provided with an operating knob 58B extending outward in the radial direction. As shown in FIG. 1, the operating knob 58B protrudes to the outside of the hammer case 51 from the knob guiding groove 51a of the hammer case 51. Because the knob guiding groove 51a is formed in the circumferential direction, the operating knob 58B can move in the circumferential direction along the knob guiding groove 51a. Hence the supporting section 58 formed integrally with the operating knob 58B can rotatably move in the circumferential direction.

As shown in FIG. 3, the contacting section 59 has an annular shape having the same diameter as that of the supporting section 58. The contacting section 59 is disposed at the front side of the supporting section 58. The contacting section 59 has four contacting-side convex sections 59A each protruding toward the supporting section 58 side (rearward). Each of the contacting-side convex sections 59A has the same shape. The rear end of each contacting-side convex section 59A has a planar shape that is perpendicular to the front-rear direction. The side surfaces of each contacting-side convex section 59A in the circumferential direction have a slope-face shape.

Contacting-side concave sections 59a are defined at four positions each between the neighboring contacting-side convex sections 59A. The contacting section 59 is so configured that the respective supporting-side convex sections 58A can be inserted in the four contacting-side concave sections 59a and that the respective contacting-side convex sections 59A can be inserted in the four supporting-side concave sections 58a. The front end surface of the contacting section 59 makes contact with the second spring 54B.

As described above, the contacting section 59 and the supporting section 58 are so configured that the convex sections and the concave sections are mutually fitted together, and that each of the convex sections of the both sections 59 and 58 has a planar surface. Thus, the restricting section 57 has a large length in the front-rear direction in a state where distal ends of the contacting-side convex sections 59A and the supporting-side convex section 58A are in contact with each other (a blocking state), whereas the restricting section 57 has a small length in the front-rear direction in a state where the convex sections and the concave sections each of the supporting section 58 and the contacting section 59 are mutually fitted together (a permitting state).

The fixing convex section 59B extending outward in the radial direction is provided at a position on the outer circumference of the contacting section 59 and corresponding to a base portion of the contacting-side convex sections 59A. The fixing convex section 59B is inserted in a groove (not shown) formed in the inner circumferential surface of the hammer case 51 such that the fixing convex section 59B can move only in the front-rear direction. Thus, the contacting section 59 can move in the front-rear direction, but cannot rotatably move in the circumferential direction.

As described above, the contacting section 59 makes contact with the hammer 53 via the second washer 56B and the second spring 54B. Hence, in the permitting state where the contacting section 59 is located rearward in comparison with the blocking state, the hammer 53 can move rearward by an amount that the second spring 54B can be compressed. Thus, in the permitting state, when a load on the anvil 52 is a predetermined amount or greater, the hammer 53 moves rearward relative to the anvil 52 against the urging force of the first spring 54A, and the hammer 53 rotates while the pawl sections 53A get over the vane sections 52E. With this operation, the hammer 53 can apply striking force to the anvil 52. In the permitting state, the motor 3 becomes a continuous rotation state in which the rotor shaft 31 rotates only in one rotational direction of either forward or reverse rotation based on the forward-reverse switching lever 24.

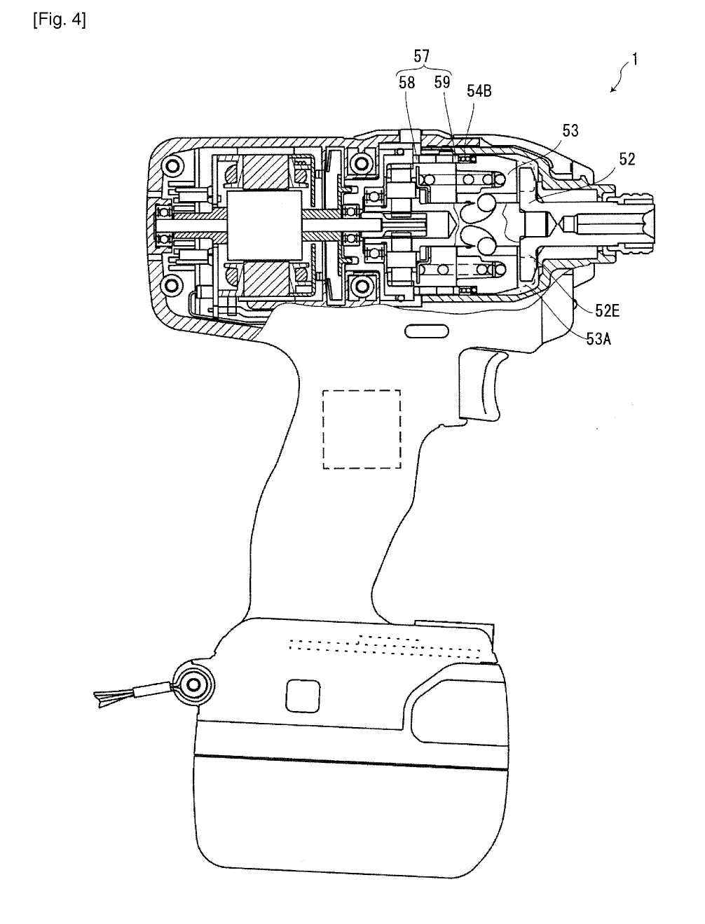

On the other hand, as shown in FIG. 4, in the blocking state, the contacting section 59 is located forward in comparison with the permitting state. Because the second spring 54B has been already compressed, the hammer 53 cannot move rearward. Thus, in the blocking state, because the hammer 53 cannot move rearward relative to the anvil 52, the pawl sections 53A do not get over the vane sections 52E. Hence, in order to apply striking force to the anvil 52, the motor 3 is pulse-driven so that the motor 3 makes alternately forward and reverse rotations repeatedly, which causes the hammer 53 to collide with the anvil 52. In the blocking state, the motor 3 becomes a forward-reverse rotation state in which the rotor shaft 31 is switched alternately between forward rotation and reverse rotation.

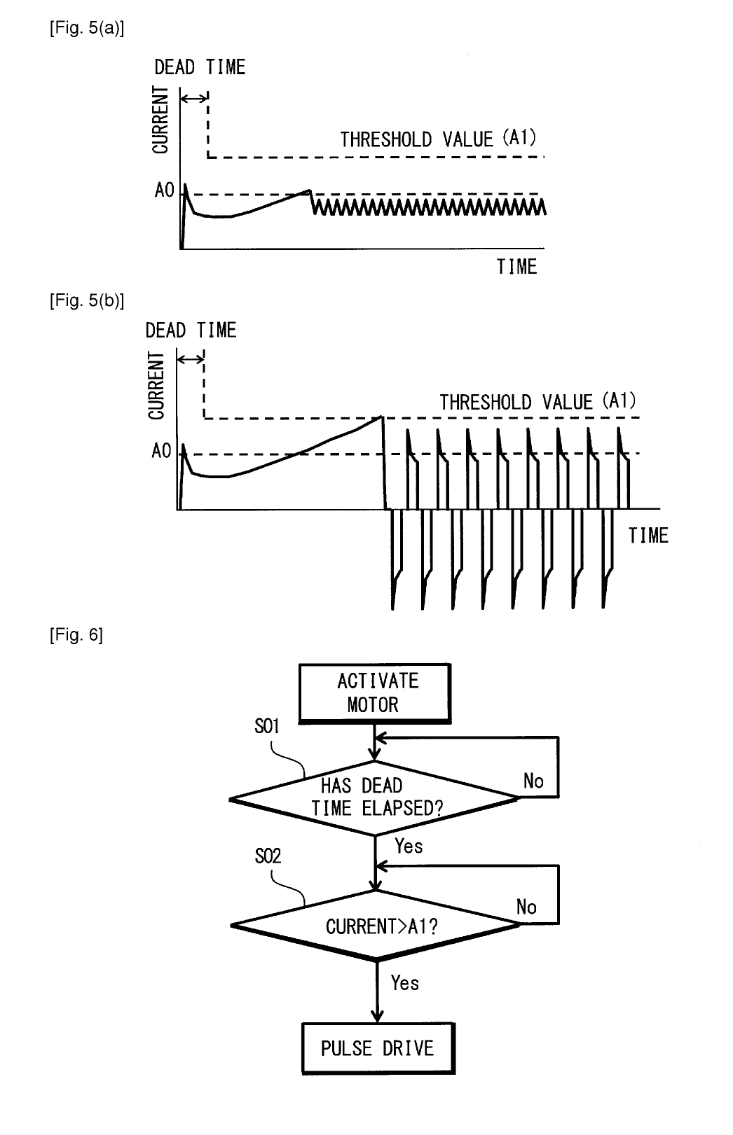

A control for switching rotations of the motor 3 between the continuous rotation state (an impact mode which is the first mode) and the forward-reverse rotation state (a pulse mode which is the second mode) in the impact tool 1 of the above-described configuration will be described while referring to the graphs in FIGS. 5(a) and 5(b) and the flowchart in FIG. 6. FIGS. 5(a) and 5(b) show relationships between current value and time when striking operations are performed in the continuous rotation state and the forward-reverse rotation state, respectively. In FIGS. 5(a) and 5(b), portions where current value changes greatly show a state in which a striking operation is performed. Note that a current value until a predetermined time point after power of the motor 3 is turned on will not be considered in this control. This is because starting power is generally large when the motor 3 starts rotation, and a large current value (starting current) caused by this starting power (starting current) is excluded from the control as a dead time. The same goes for first to third modifications described later.

In the permitting state, as an end bit (not shown) digs into a workpiece or the like, the rotation of the end bit is restricted (locked) and there is a load on the motor 3. When axial torque of the motor 3 becomes large, that is, the load on the motor 3 becomes large to some extent (a current value becomes large), the pawl sections 53A get over the vane sections 52E (the motor 3 rotates) and hence, after that, the current value does not increase. That is, as shown in FIG. 5(a), in the continuous rotation state, the current value becomes a maximum value A0 immediately before a striking operation is started (that is, when the pawl sections 53A get over the vane sections 52E for the first time). Subsequently, the current value is rapidly dropped and then the current value increases until the pawl sections 53A get over the vane sections 52E in upward portions where the current value increases in upward-sloping curves in FIG. 5(a) and, after that, the current value decreases in downward portions where the current value decreases in downward-sloping curves in FIG. 5(a)). These states are repeatedly performed and the motor 3 is driven in the impact mode.

On the other hand, in the blocking state, because the pawl sections 53A do not get over the vane sections 52E, axial torque of the motor 3 (current value according to the axial torque) becomes larger than the maximum value A0 of current values in the continuous rotation state. Thus, as shown in FIG. 5(b), the current value increases in an upward-sloping curve, and becomes larger than the maximum value A0 of current values in FIG. 5(a). Accordingly, a value larger than the maximum value in FIG. 5(a) is set as a threshold value A1 (prescribed value, predetermined value, and current threshold value). The threshold value A1 is larger than the maximum value A0 which is a current value when the pawl sections 53A get over the vane sections 52E. When the current value becomes larger than the threshold value A1, a rotation state of the motor 3 is changed from the continuous rotation state (impact mode) to the forward-reverse rotation state (pulse mode). In FIG. 5(b), portions shown below the time axis are reverse operations, and portions shown above the time axis are forward operations. The motor 3 is driven in the pulse mode in which forward rotation and reverse rotation are repeatedly performed. That is, when the current value becomes larger than the threshold value A1, the control circuit section 100 determines that the restricting section 57 restricts the movement of the hammer 53 (blocking state). On the other hand, when the current value is smaller than the threshold value A1, the control circuit section 100 determines that the restricting section 57 does not restrict the movement of the hammer 53 (permitting state).

Specifically, as shown in the flowchart of FIG. 6, first, the trigger 23A is pulled to activate the motor 3. At the startup of the motor 3, the motor 3 is in the continuous rotation state (impact mode) which is a normal rotation state. Subsequently, in S01, the arithmetic section 110 determines based on the timer 117 whether dead time has elapsed. If not (S01: No), then the arithmetic section 110 waits for the passage of the dead time. If so (S01: Yes), then the arithmetic section 110 proceeds to S02 and determines whether a current value detected by the current detecting circuit 114 is larger than the threshold value A1. If not (S02: No), then the routine returns to S02. If so (S02: Yes), then the arithmetic section 110 controls the motor 3 to pulse-drive and changes the rotation state to the forward-reverse rotation state (pulse mode) and ends the process in the flowchart.

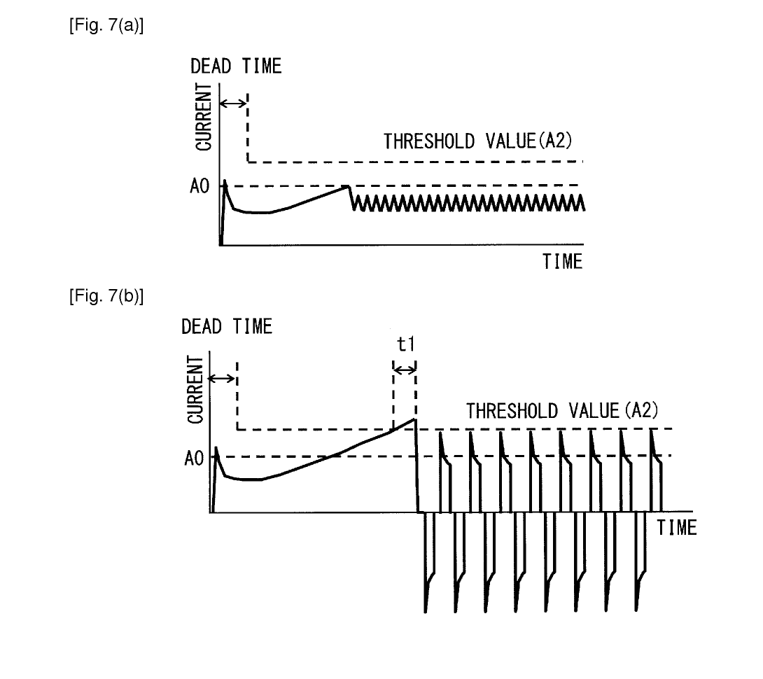

In the above-described flowchart, changing the rotation state of the motor 3 from the continuous rotation state to the forward-reverse rotation state is determined based on whether the current value is larger than the threshold value A1 and whether to be in the blocking state or the permitting state. On the other hand, as a first modification, in order to make more accurate determination, as shown in FIGS. 7(a) and 7(b), the rotation state may be changed to the forward-reverse rotation state if a state where the current value is larger than a threshold value A2 continues for a predetermined period of time t1 (current-threshold-value reached continuation time period t1) after the current value reaches the threshold value A2. Note that the threshold value A2 is preferably smaller than the threshold value A1 but larger than the maximum value A0, considering a load on the motor 3. For example, the values are set such that the threshold value A1 is 40 A, the threshold value A2 is 38 A, and the predetermined period of time t1 is 200 msec. The threshold value A1 may be the same as the threshold value A2.

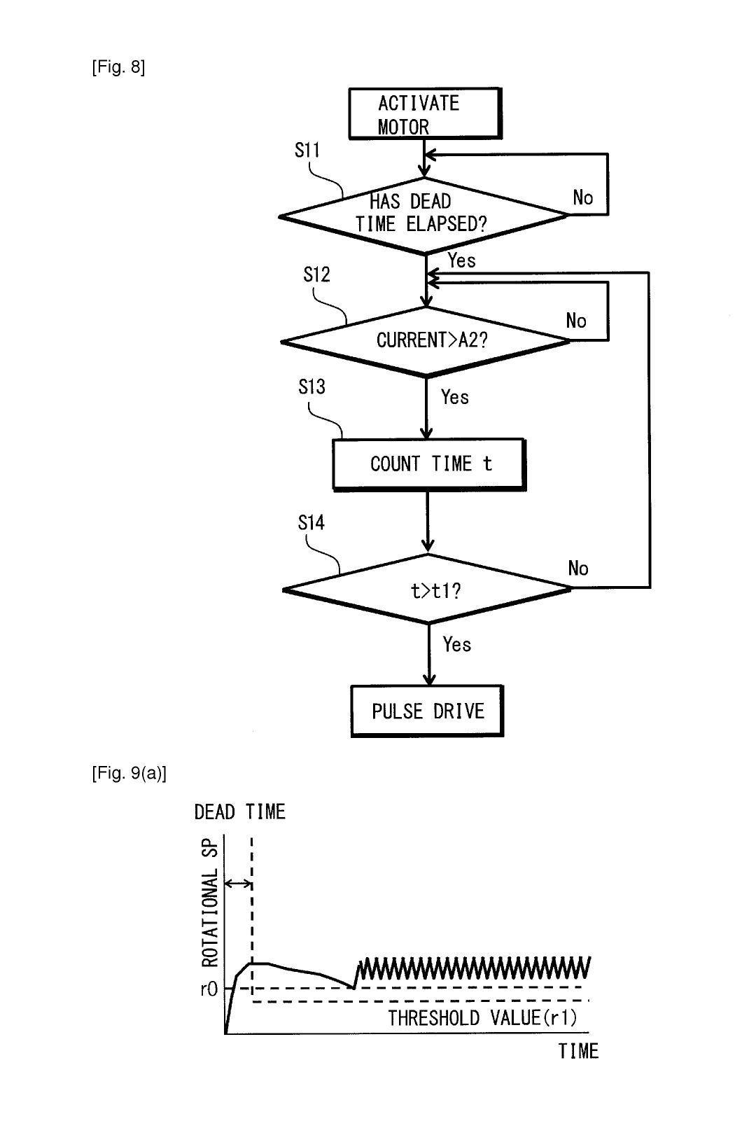

Specifically, as shown in the flowchart of FIG. 8, first, the trigger 23A is pulled to activate the motor 3. Subsequently, in S11, the arithmetic section 110 determines based on the timer 117 whether dead time has elapsed. If not (S11: No), then the arithmetic section 110 waits for the passage of the dead time. If so (S11: Yes), then the arithmetic section 110 proceeds to S12 and determines whether a current value detected by the current detecting circuit 114 is larger than the threshold value A2. If not (S12: No), then the routine returns to S12. If so (S12: Yes), then the arithmetic section 110 proceeds to S13 and uses the timer 117 to count a time period t that has elapsed after a time point at which the current value exceeds the threshold value A2. The arithmetic section 110 then proceeds to S14 and determines whether the time period t is larger than the predetermined period of time t1. If not (S14: No), then the routine returns to S12. If so (S14: Yes), then the arithmetic section 110 controls the motor 3 to pulse-drive and changes the rotation state to the forward-reverse rotation state and ends the process in the flowchart. Note that after counting of the time period t is started in S13, the current value may be continuously detected by the current detecting circuit 114. In this case, if the current value becomes smaller than the threshold value A2 before a lapse of the predetermined period of time t1, the arithmetic section 110 may reset the timer 117 and returns to S12. In this way, modes can be switched more reliably.

With this control, even if an abnormal value occurs locally and instantaneously in a state where the restricting section 57 is in the permitting state and thus the forward-reverse rotation state of the motor 3 is not needed, the abnormal value can be excluded and malfunction can be prevented.

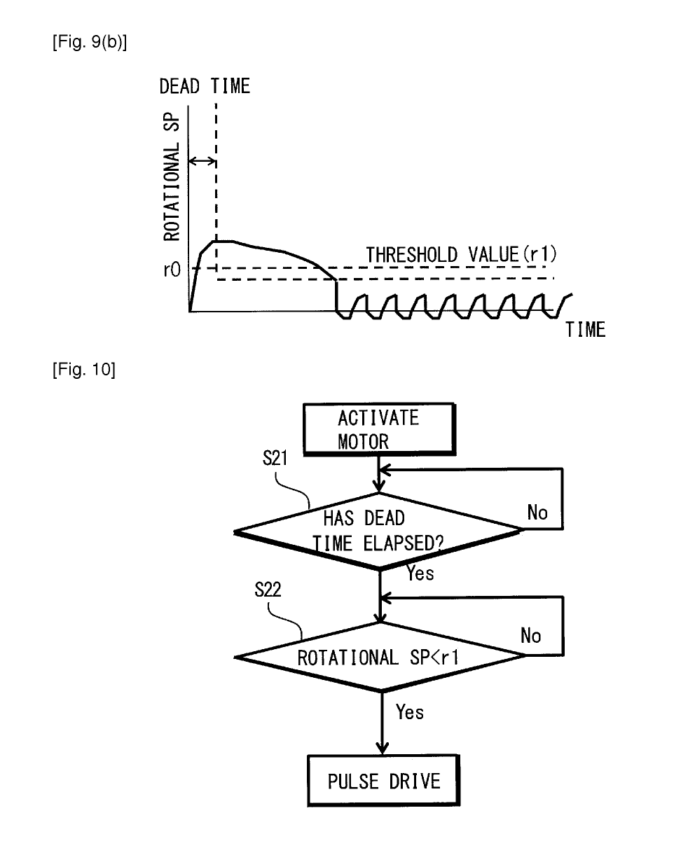

In the above-described embodiment and the first modification, the continuous rotation state and the forward-reverse rotation state are determined with reference to a current value. Alternatively, as a second modification, as shown in FIGS. 9(a) and 9(b), the state may be determined with reference to a rotational speed. FIGS. 9(a) and 9(b) show relationships between rotational speed and time when striking operations are performed in the continuous rotation state and the forward-reverse rotation state, respectively. In FIGS. 9(a) and 9(b), portions where rotational speed changes greatly show a state in which a striking operation is performed.

In the permitting state (impact mode), in a state where an end bit (not shown) digs into a workpiece or the like and there is a load on the motor 3, rotational speed increases once in a low load state and decreases due to an increase of the load. Then, at the timing when the load on the motor 3 becomes large to some extent (the rotational speed becomes small), the pawl sections 53A get over the vane sections 52E to increase the rotational speed of the motor 3 and hence, after that, the rotational speed does not decrease by a predetermined amount. That is, as shown in FIG. 9(a), in the continuous rotation state, the rotational speed decreases to the smallest value r0 immediately before a striking operation is started (that is, when the pawl sections 53A get over the vane sections 52E for the first time). Subsequently, the rotational speed decreases until the pawl sections 53A get over the vane sections 52E in downward portions where the rotational speed decreases in downward-sloping curves in FIG. 9(a) and, after that, the rotational speed increases in upward portions where the rotational speed increases in upward-sloping curves in FIG. 9(a). These states are repeatedly performed and the motor 3 is driven in the impact mode.

On the other hand, in the blocking state, because the pawl sections 53A do not get over the vane sections 52E, the rotational speed of the motor 3 in the forward-reverse rotation state becomes smaller than the rotational speed in the continuous rotation state. Thus, as shown in FIG. 9(b), the rotational speed decreases in a downward-sloping curve, and becomes smaller than a minimum value of rotational speed in FIG. 9(a). Accordingly, a value smaller than the smallest value r0 in FIG. 9(a) is set as a threshold value r1 (prescribed value, rotational threshold value). That is, the threshold value r1 is smaller than the smallest value r0 which is a rotational speed when the pawl sections 53A get over the vane sections 52E. When the rotational speed becomes smaller than the threshold value r1, a rotation state of the motor 3 is changed from the continuous rotation state to the forward-reverse rotation state (pulse mode). In FIG. 9(b), portions shown below the time axis are reverse operations, and portions shown above the time axis are forward operations. The motor 3 is driven in the pulse mode in which forward rotation and reverse rotation are repeatedly performed.

Specifically, as shown in the flowchart of FIG. 10, first, the trigger 23A is pulled to activate the motor 3. Subsequently, in S21, the arithmetic section 110 determines based on the timer 117 whether dead time has elapsed. If not (S21: No), then the arithmetic section 110 waits for the passage of the dead time. If so (S21: Yes), then the arithmetic section 110 proceeds to S22 and determines whether a rotational speed detected by the motor rotational-speed detecting circuit 116 is smaller than the threshold value r1. If not (S22: No), then the routine returns to S22. If so (S22: Yes), then the arithmetic section 110 controls the motor 3 to pulse-drive and changes the rotation state to the forward-reverse rotation state and ends the process in the flowchart.

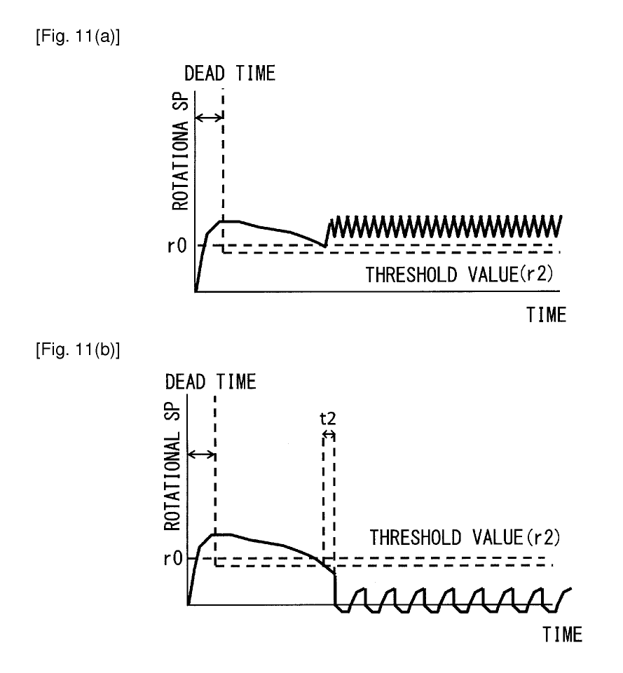

As a third modification, like the first modification, in a control based on rotational speed, as shown in FIGS. 11(a) and 11(b), the rotation state of the motor 3 may be changed from the continuous rotation state to the forward-reverse rotation state if a state where the rotational speed is smaller than a threshold value r2 continues for a predetermined period of time t2 (a rotational-speed threshold-value reached continuation time period t2) after the rotational speed reaches the threshold value r2. Note that the threshold value r2 is preferably larger than the threshold value r1 but smaller than the smallest value r0, considering a load on the motor 3. For example, the values are set such that the threshold value r1 is 7400 rpm, the threshold value r2 is 8100 rpm, and the predetermined period of time t2 is 200 msec. The threshold value r2 may be the same as the threshold value r1.

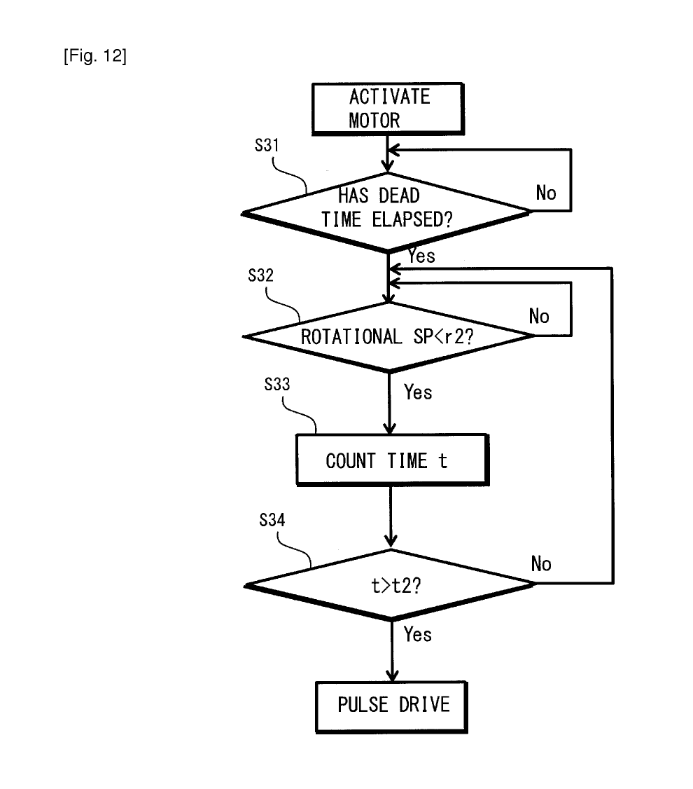

Specifically, as shown in the flowchart of FIG. 12, first, the trigger 23A is pulled to activate the motor 3. Subsequently, in S31, the arithmetic section 110 determines based on the timer 117 whether dead time has elapsed. If not (S31: No), then the arithmetic section 110 waits for the passage of the dead time. If so (S31: Yes), then the arithmetic section 110 proceeds to S32 and determines whether a rotational speed detected by the motor rotational-speed detecting circuit 116 is smaller than the threshold value r2. If not (S32: No), then the routine returns to S32. If so (S32: Yes), then the arithmetic section 110 proceeds to S33 and uses the timer 117 to count a time period t that has elapsed after a time point at which the rotational speed falls below the threshold value r2. The arithmetic section 110 then proceeds to S34 and determines whether the time period t is larger than the predetermined period of time t2. If not (S34: No), then the routine returns to S32. If so (S34: Yes), then the arithmetic section 110 controls the motor 3 to pulse-drive and changes the rotation state to the forward-reverse rotation state and ends the process in the flowchart. Note that after counting of the time period t is started in S33, the rotational speed may be continuously detected by the motor rotational-speed detecting circuit 116. In this case, if the rotational speed becomes larger than the threshold value r2 before a lapse of the predetermined period of time t2, the arithmetic section 110 may reset the timer 117 and return to S32. In this way, modes can be switched more reliably.

According to the above-described embodiment and the first to third modifications, the rotation state can be selected between the continuous rotation state and the forward-reverse rotation state depending on a load condition of the motor 3 and a state of the restricting section 57, without using an electrical switch for switching modes. In the continuous rotation state (impact mode), striking force in the rotational direction and the axial direction can be generated based on movement of the hammer 53 relative to the anvil 52 in the axial direction. In the forward-reverse rotation state (pulse mode), striking force in the rotational direction can be generated based on forward and reverse rotations (pulse drive) of the motor 3. Hence, in the continuous rotation state, strong fastening due to continuous striking can be performed. In the forward-reverse rotation state, because the motor 3 is pulse-driven and the pawl sections 53A do not get over the vane sections 52E, striking noises can be reduced.

In the above-described embodiment and modifications, the impact tool is so configured that the continuous rotation mode (impact mode) and the forward-reverse rotation mode (pulse mode) are switched mechanically by the restricting section 57 shown in FIG. 3. That is, it is switched by the restricting section 57 whether movement of the hammer 53 in the axial direction is permitted or restricted. Because the restricting section 57 and the control circuit section 100 (especially, the arithmetic section 110) for controlling the motor 3 are not electrically connected to each other, the control circuit section 100 cannot switch the driving mode of the motor 3 in accordance with switching of the restricting section 57.

Hence, an electrical switch for turning on/off in conjunction with movement of the restricting section 57 may be provided, so that the control circuit section 100 switches the driving mode of the motor 3 in accordance with on/off signals of the electrical switch. In the impact tool, however, because a screw fastening operation is performed with striking force of the hammer 53 and the anvil 52, there is a possibility that chattering occurs in a contact of the electrical switch due to vibrations that is generated during an operation such as striking etc., and that the control circuit section cannot detect switching of modes accurately.

Thus, the invention provides an impact tool capable of switching modes appropriately without using an electrical switch that operates in conjunction with movement of the restricting section 57. With the invention, a current flowing through the motor 3 or a rotational speed of the motor 3 is detected, and the modes are switched based on the current or the rotational speed. If the current becomes larger than the threshold value A1 or if the rotational speed of the motor 3 falls below the threshold value r1, it is determined that the mode is the pulse mode in which rearward movement of the hammer 53 is restricted by the restricting section 57. At this time, the arithmetic section 110 controls the switching elements Q1-Q6 of the inverter circuit section 102 to pulse-drive the motor 3. With this configuration, the modes can be switched appropriately, without being affected by chattering of an electrical switch. Further, because an electrical switch is not used, the number of parts does not increase and manufacturing costs can be reduced. In addition, the current detecting section and the rotational-speed detecting section are necessary for protecting the motor and the inverter circuit section from overload and for detecting a rotor position in case of a brushless motor, and these sections need not be newly provided. In this regard, too, manufacturing costs can be reduced.

Further, the above-described embodiment and modifications are described assuming that the first mode is the impact mode and the second mode is the pulse mode.

However, the control is not limited to that forward and reverse rotations are repeated to drive the motor, and other modes can be used. For example, the second mode may be an electronic clutch mode. The electronic clutch mode is a mode in which a motor is stopped when current value through the motor exceeds a predetermined value. In this case, if a threshold value of current is not fixed (constant) and can be switched (changed) arbitrarily, timing of stopping the motor can be changed, and threshold values can be selectively used depending on the purpose.

### REFERENCE SIGNS LIST

1: impact tool, 2: housing, 2A: body section, 2B: handle, 2a: air inlet port, 3: motor, 3A: stator, 3B: rotor, 4: gear mechanism, 4A: frame body, 4B: bearing, 5: impact mechanism, 6: battery, 23A: trigger, 23B: switch section, 24: forward-reverse switching lever, 31: rotor shaft, 31A: bearing, 31B: bearing, 32: fan, 33: pinion gear, 41: spindle, 41A: flange section, 41B: ball, 41a: groove, 42: ring gear, 43: planetary gear, 51: hammer case, 51A: metal bearing, 51a: knob guiding groove, 52: anvil, 52A: end-bit mounting section, 52D: operating section, 52E: vane section, 52a: bore, 52b: mount hole, 53: hammer, 53A: pawl section, 53B: spring receiving section, 53a: through-hole, 53b: groove, 53c: receiving section, 54A: first spring, 54B: second spring, 56A: first washer, 56B: second washer, 57: restricting section, 58: supporting section, 58A: supporting-side convex section, 58B: operating knob, 58a: supporting-side concave section, 59: contacting section, 59A: contacting-side convex section, 59B: fixing convex section, 59a: contacting-side concave section, 100: control circuit section, 102: inverter circuit section, 110: arithmetic section, 111: switch-operation detecting circuit, 112: application-voltage setting circuit, 113: rotational-direction setting circuit, 114: current detecting circuit, 115: rotor-position detecting circuit, 116: motor rotational-speed detecting circuit, 117: timer, 119: control-signal outputting circuit

1. An impact tool comprising:
a motor configured to be rotatable either in a forward direction or a reverse direction, the motor having an output shaft defining an axial direction;
a hammer configured to be driven by the motor and movable in the axial direction;
an anvil configured to be struck by the hammer and hold an end tool;
a control unit configured to control a rotation of the motor; and
a restricting unit configured to restrict the movement of the hammer in the axial direction,
wherein the control unit is configured to select a driving mode of the motor between a first mode and a second mode different from the first mode, the control unit including a load detection unit configured to detect a load of the motor, and
wherein the control unit selects the first mode when the load detected by the load detection unit is less than or equal to a prescribed value regardless of a restriction of the restricting unit, whereas the control unit selects the second mode when the load detected by the load detection unit exceeds the prescribe value and the restricting unit restricts the movement of the hammer.

2. The impact tool according to claim 1, wherein the control unit determines whether or not the restricting unit restricts the movement of the hammer based on the load detected by the detection unit,
wherein the control unit determines that the restricting unit restricts the movement of the hammer when the load detected by the load detection unit exceeds the prescribed value, whereas the control unit determines that the restricting unit does not restrict the movement of the hammer when the load detected by the load detection unit is less than or equal to the prescribed value.

3. The impact tool according to claim 1, wherein the load detection unit includes a current detection unit configured to detect a current flowing to the motor,
wherein the control unit selects the first mode when the current detected by the current detection unit is less than or equal to a predetermined value regardless of the restriction of the restricting unit, whereas the control unit selects the second mode when the current detected by the current detection unit exceeds the predetermined value and the restricting unit restricts the movement of the hammer.

4. The impact tool according to claim 3, wherein the control unit determines whether or not the restricting unit restricts the movement of the hammer based on the current detected by the current detection unit,
wherein the control unit determines that the restricting unit restricts the movement of the hammer when the current detected by the current detection unit exceeds the predetermined value, whereas the control unit determines that the restricting unit does not restrict the movement of the hammer when the current detected by the current detection unit is less than or equal to the predetermined value.

5. The impact tool according to claim 1, wherein the motor is continuously driven in one of the forward and reverse directions in the first mode, and the motor is alternately driven in the forward and reverse directions in the second mode.

6. An impact tool comprising:
a motor configured to be rotatable either in a forward direction or a reverse direction, the motor having an output shaft defining an axial direction;
a hammer configured to be driven by the motor and movable in the axial direction;
an anvil configured to be struck by the hammer and hold an end tool, the hammer being configured to get over the anvil upon the movement in the axial direction; and
a control unit configured to control a rotation of the motor, the control unit including a current detection unit configured to detect a current flowing to the motor and a mode selecting unit configured to select a driving mode of the motor between a first mode and a second mode based on the current detected by the current detection unit, the motor being continuously rotated in one of the forward and reverse directions in the first mode, the motor being alternately rotated in the forward and reverse directions in the second mode, the mode selecting unit selecting the second mode when the current detected by the current detection unit exceeds a current threshold value, the current threshold value being larger than a current when the hammer gets over the anvil.

7. The impact tool according to claim 6, wherein the control unit includes a timer unit configured to count a time,
wherein the mode selecting unit selects the second mode when the current detected by the current detection unit exceeds the current threshold value for a predetermined period of time counted by the timer unit.

8. The impact tool according to claim 6, wherein the control unit includes a timer unit configured to count a time,
wherein the mode selecting unit selects the second mode when the current detected by the current detection unit exceeds a threshold value for a predetermined period of time counted by the timer unit, the threshold value being smaller than the current threshold value and larger than the current when the hammer gets over the anvil.

9. The impact tool according to claim 6, further comprising a restricting unit configured to restrict the movement of the hammer in the axial direction,
wherein the selecting unit is capable of selecting the second mode based on the current detected by the current detection unit when the restricting unit restricts the movement of the hammer.

10. An impact tool comprising:
a motor configured to be rotatable either in a forward direction or a reverse direction, the motor having an output shaft defining an axial direction;
a hammer configured to be driven by the motor and be movable in the axial direction;
an anvil configured to be struck by the hammer and hold an end tool, the hammer being configured to get over the anvil upon the movement in the axial direction; and
a control unit configured to control a rotation of the motor, the control unit including a rotational speed detection unit configured to detect a rotational speed of the motor and a mode selecting unit configured to select a driving mode of the motor between a first mode and a second mode based on the rotational speed detected by the rotational speed detection unit, the motor being continuously rotated in one of the forward and reverse directions in the first mode, the motor being alternately rotated in the forward and reverse directions in the second mode, the mode selecting unit selecting the second mode when the rotational speed detected by the rotational speed detection unit is lower than or equal to a rotational threshold value, the rotational threshold value being smaller than a rotational speed when the hammer gets over the anvil.

11. The impact tool according to claim 10, wherein the control unit includes a timer unit configured to count a time,
wherein the mode selecting unit selects the second mode when the rotational speed detected by the rotational speed detection unit is lower than or equal to the rotational threshold value for a predetermined period of time counted by the timer unit.

12. The impact tool according to claim 10, wherein the control unit includes a timer unit configured to count a time,
wherein the mode selecting unit selects the second mode when the rotational speed detected by the rotational speed detection unit is lower than or equal to a threshold value for a predetermined period of time counted by the timer unit, the threshold value being larger than the rotational threshold value and smaller than the rotational speed when the hammer gets over the anvil.

13. The impact tool according to claim 10, further comprising a restricting unit configured to restrict the movement of the hammer in the axial direction,
wherein the selecting unit is capable of selecting the second mode based on the rotational speed detected by the rotational speed detection unit when the restricting unit restricts the movement of the hammer.

14. An impact tool comprising:
a motor configured to be rotatable either in a forward direction or a reverse direction, the motor having an output shaft defining an axial direction;
an anvil configured to hold an end tool, the anvil including an engaged section;
a hammer configured to be driven by the motor and be movable in the axial direction, the hammer including an engaging section configured to engage the engaged section of the anvil so as to rotatingly drive the anvil;
an urging member configured to urge the hammer toward the anvil in the axial direction, wherein the hammer rotatingly moves in the axial direction against the urging member, so that the engaging section gets over the engaged section; and
a control unit configured to control a rotation of the motor, the control unit including at least one of a rotational speed detection unit and a current detection unit, the rotational speed detection unit being configured to detect a rotational speed of the motor, the current detection unit being configured to detect a current flowing to the motor, the control unit further including a mode selecting unit configured to select a driving mode of the motor between a first mode and a second mode, the motor being continuously rotated in one of the forward and reverse directions in the first mode, the motor being alternately rotated in the forward and reverse directions in the second mode, the mode selecting unit selecting the second mode when the rotational speed detected by the rotational speed detection unit is lower than or equal to a rotational threshold value or when the current detected by the current detection unit exceeds a current threshold value, the current threshold value being larger than a current when the hammer gets over the anvil, the rotational threshold value being smaller than a rotational speed when the engaging section gets over the engaged section.

15. The impact tool according to claim 14, wherein the control unit includes a timer unit configured to count a time,
wherein the mode selecting unit selects the second mode when the current detected by the current detection unit exceeds the current threshold value or when the rotational speed detected by the rotational speed detection unit is lower than or equal to the rotational threshold value for a predetermined period of time counted by the timer unit.

16. An impact tool comprising:
a motor configured to be rotatable either in a forward direction or a reverse direction, the motor having an output shaft defining an axial direction;
a hammer configured to be driven by the motor and movable in the axial direction;
an anvil configured to be struck by the hammer and hold an end tool; and
a restricting unit configured to restrict the movement of the hammer in the axial direction,
wherein a drive mode of the motor is configured to be automatically switched when the restricting unit restricts the movement of the hammer.

17. An impact tool comprising:
a motor configured to be rotatable either in a forward direction or a reverse direction, the motor having an output shaft defining an axial direction;
a hammer configured to be driven by the motor and movable in the axial direction;
an anvil configured to be struck by the hammer and hold an end tool; and
a restricting unit configured to restrict the movement of the hammer in the axial direction and a load detection unit configured to detect a load of the motor,
wherein the motor is driven in a first mode when the load detected by the load detection unit is less than or equal to a prescribed value, whereas the motor is driven in a second mode different from the first mode when the load detected by the load detection unit exceeds the prescribe value and the restricting unit restricts the movement of the hammer.
